(19) United States
(12) Patent Application Publication
(10) Pub. No.: US 2016/0094651 A1
(43) Pub. Date: Mar. 31, 2016

(54) METHOD OF PROCURING INTEGRATING AND SHARING SELF POTRAITS FOR A SOCIAL NETWORK

(71) Applicants: Umm-Al-Qura University, MAKKAH (SA); Umm Al-Qura University, MAKKAH (SA)

(72) Inventors: ANAS BASALAMAH, MAKKAH (SA); SALEH BASALAMAH, MAKKAH (SA); Mohamed Abdelghany, MAKKAH (SA); Mostafa Ali Mohamed Ali, MAKKAH (SA)

(21) Appl. No.: 14/868,636

(22) Filed: Sep. 29, 2015

Related U.S. Application Data
(60) Provisional application No. 62/057,242, filed on Sep. 30, 2014.

(51) Int. Cl. H04L 29/08; G06T 11/60; H04N 5/225

(52) U.S. Cl. CPC H04L 67/1076; H04N 5/225; G06T 11/60

(57) ABSTRACT

This invention relates to a system, software and method to procure, share, and join selfie in a given social network. The usual existing and new methods of sharing and connecting may be used for implementing this software as used as computer implemented method. Hardware is used for procuring, sharing and integrating the software as a system.

### CROSS REFERENCE TO RELATED APPLICATION

This application claims priority to U.S. Provisional Application No. 62/057,242 filed on Sep. 30, 2014. The pending U.S. application Ser. No. 62/057,242 is hereby incorporated by reference in its entireties for all of its teachings.

### FIELD OF TECHNOLOGY

The disclosure generally relates to a method of procuring photographs by individuals, integrating with their social media friends and sharing it as self-portraits.

### BACKGROUND

A selfie is a self-portrait photograph, typically taken with a hand-held digital camera or camera phone. Selfies are often shared on social networking services such as Facebook, Instagram, Snapchat, Tumblr and Twitter. They are often casual, and are typically taken either with a camera held at arm's length or in a minor. Taking Selfie photos is becoming a very popular social activity everywhere in the world. Many people like to add a message to the photo by annotating few words, similes, or hand drawings, to be saved and shared. A selfie can be for a person by himself or a group of people as long as they can be covered by the camera's view. There is need for a better technology for sharing and viewing.

### SUMMARY

The present invention describes a social network platform for taking and sharing selfie photos with friends not necessarily present at the initiator's location. Photos can then be annotated, edited, stored and shared in social networks. In one embodiment, disclosure relates to a group selfie, people do not have to be present at the same physical location. A computer implemented method of harvesting and joining selfies taken by a group of individuals who are connected or want to be connected to each other using a social media. Once the permissions are granted for using their selfies, a computer aided algorithm enables a user to use the graphical user interface to organize the individual photographs in a logical group setting. Once the group photograph has been assembled permission from the participants are acquired and the group selfies is posted or shared or printed or used for other activities.

The current and future capturing mechanism such as eye glasses, drone captured pictures, cell phone tablet or any other means of capturing the photograph are included in this invention. The photographs may be stored in cloud or databases and the hardware and software may be connected using internet.

A method for procuring, integrating and sharing self-portraits with a stitched image using a social media is done by providing lists of friends for a user to interact with. The users can be matched from contact list, social network APIs, invited by email or text message to join the platform. The user who decides to take a group selfie can invite contact from his friends list or a group of contacts to take a group selfie. Invites will be sent to selected user(s) who will be poked to accept the group selfie invitation. Once user(s) accept the invitation, their cameras will be activated and they can select their most liked pose and take a selfie, within a certain time window. The cumulatively taken selfies will be collected at user devices, or at server, for editing, annotation, and collage making, and consequently stored, or shared through social network. Note that this system could be implemented as a standalone application, or as an add-on to currently implemented systems like Facebook, GooglePlus, Twitter, etc.

According to one embodiment, there is provided a computer-implemented method comprising: receiving input commands from a given user to take a self-portrait with a camera; inviting contact users of said given user to participate in a group self-portrait, wherein each contact user is invited to take a self-portrait within a predetermined time period via a computer network; and receiving the self-portraits from the contact users through the computer network.

In an embodiment, the computer-implemented method comprises receiving input commands from the given user to edit the self-portrait of the given user and the self-portraits of the contact users.

In an embodiment, the computer-implemented method comprises receiving input commands from the given user to annotate the self-portrait of the given user and the self-portraits of the contact users.

In an embodiment, the computer-implemented method comprises receiving input commands from the given user to generate a collage of the self-portrait of the given user and the self-portraits of the contact users.

In an embodiment, the computer-implemented method comprises receiving input commands from the given user to share through a social network the collage of the self-portrait of the given user and the self-portraits of the contact users.

According to another embodiment, there is provided a system comprising a screen; a camera; a memory; and one or more processors coupled to the memory, wherein the memory comprises program instructions to: receive input commands from a given user to take a self-portrait with the camera; invite contact users of said given user to participate in a group self-portrait, wherein each contact user is invited to take a self-portrait within a predetermined time period via a computer network; receive the self-portraits from the contact users through the computer network.

In an embodiment of the system, the program instructions are configured to receive input commands from the given user to edit the self-portrait of the given user and the self-portraits of the contact users.

In an embodiment of the system, the program instructions are configured to receive input commands from the given user to annotate the self-portrait of the given user and the self-portraits of the contact users.

In an embodiment of the system, the program instructions are configured to receive input commands from the given user to generate a collage of the self-portrait of the given user and the self-portraits of the contact users.

In an embodiment of the system, the program instructions are configured to receive input commands from the given user to share through a social network the collage of the self-portrait of the given user and the self-portraits of the contact users.

According to another embodiment, there is provided an apparatus configured to take a self-portrait, comprising a screen; a camera; a memory; and one or more processors coupled to the memory, wherein the memory comprises program instructions to: receive input commands from a given user to take a self-portrait with the camera; invite contact users of said given user to participate in a group self-portrait, wherein each contact user is invited to take a self-portrait within a predetermined time period via a computer network; receive the self-portraits from the contact users through the computer network.

In an embodiment of the apparatus, the program instructions are configured to store the received self-portraits from the contact users in the memory.

In an embodiment of the apparatus, the program instructions are configured to receive input commands from the given user to edit the self-portrait of the given user and the self-portraits of the contact users.

In an embodiment of the apparatus, the program instructions are configured to receive input commands from the given user to annotate the self-portrait of the given user and the self-portraits of the contact users.

In an embodiment of the apparatus, the program instructions are configured to receive input commands from the given user to generate a collage of the self-portrait of the given user and the self-portraits of the contact users.

In an embodiment of the apparatus, the program instructions are configured to receive input commands from the given user to share through a social network the collage of the self-portrait of the given user and the self-portraits of the contact users.

### BRIEF DESCRIPTION OF THE DRAWINGS

FIG. 1 shows a wireless phone with a splash screen of a group selfie application.

FIG. 2 shows a login window of the group selfie application.

FIG. 3 shows an account sign up window of the group selfie application.

FIG. 4 shows a verification code window of the group selfie application.

FIG. 5 shows a list of contacts in the group selfie application.

FIG. 6 shows a single contact with a plurality of images in the group selfie application.

FIG. 7 shows a single image selected from the plurality of images in the group selfie application.

FIG. 8 shows an edition window of the selected image in the group selfie application.

FIG. 9 shows a filter edition window of the selected image in the group selfie application.

FIG. 10 shows a text edition window of the selected image in the group selfie application.

FIG. 11 shows a request group selfie window in the group selfie application.

FIG. 12 shows a take selfie window in the group selfie application.

FIG. 13 shows a plurality of group selfies in the group selfie application.

FIG. 14 shows a flowchart of a computer-implemented method for making group selfies.

FIG. 15 shows a block diagram of a system for making group selfies.

### DETAILED DESCRIPTION

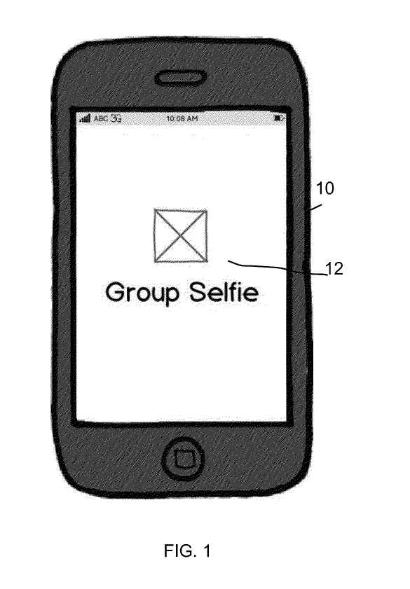

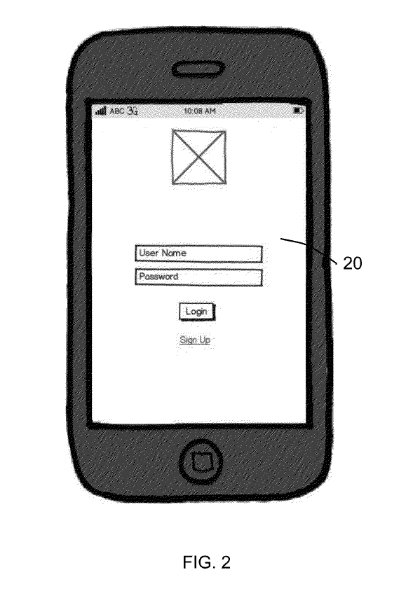

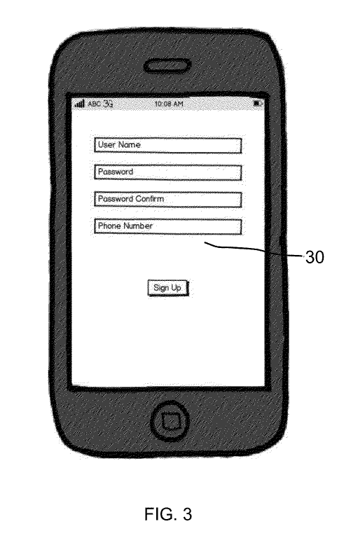

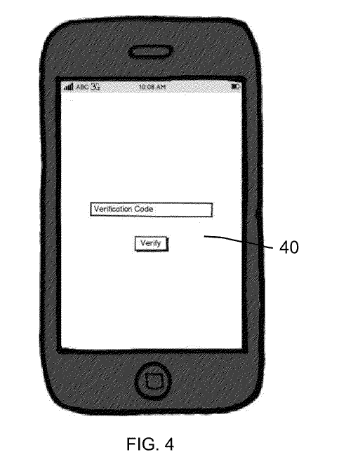

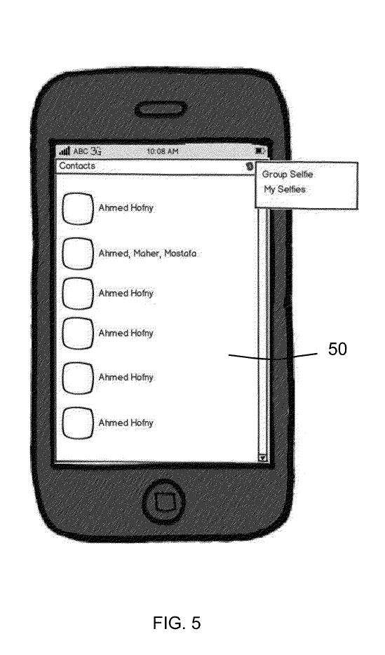

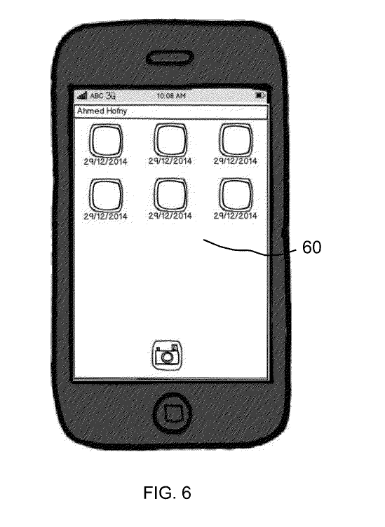

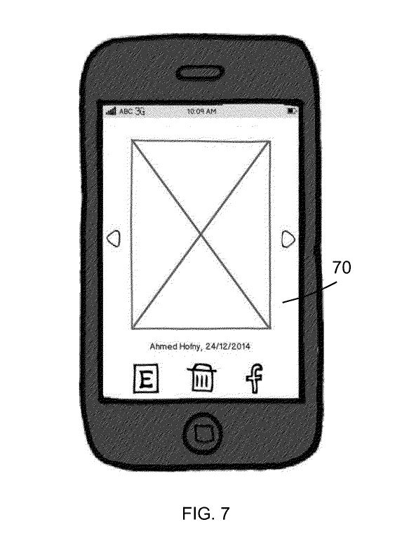

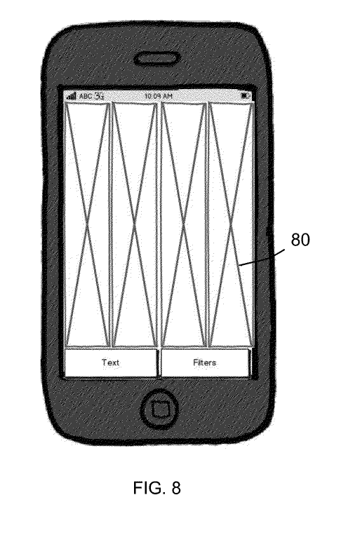

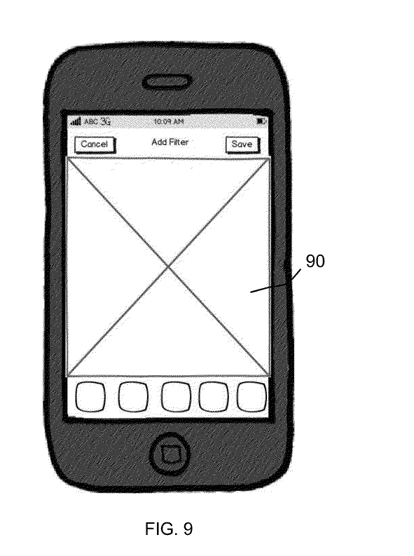

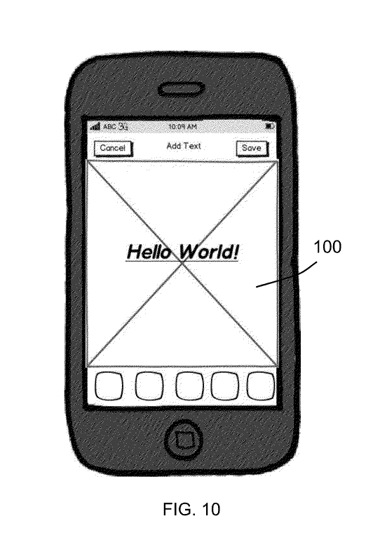

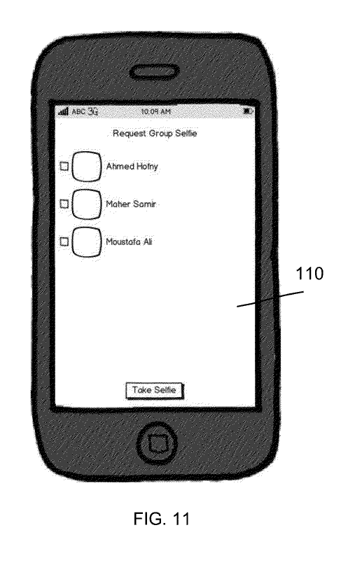

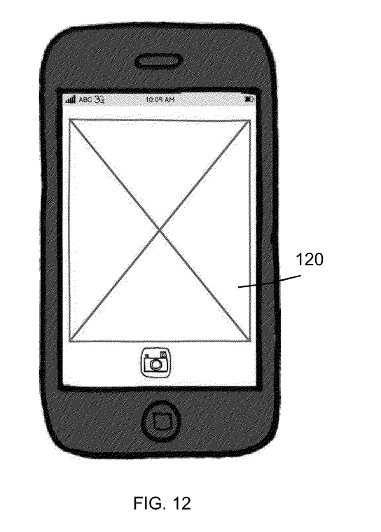

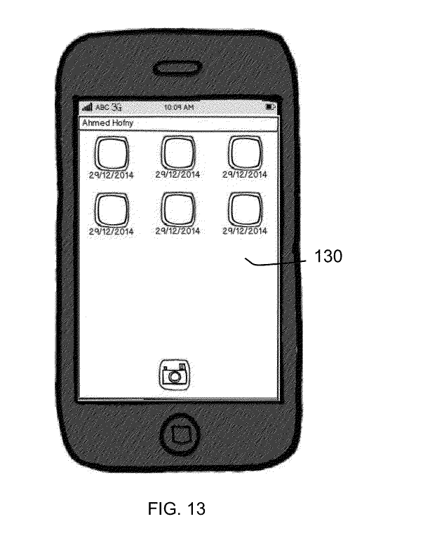

FIG. 1 shows a wireless phone 10 with a splash screen of a group selfie application 12 that a user may install and interact with in order to create a group self portrait. As shown in FIG. 2, the application starts by requesting the user name and password in window 20. As shown in FIG. 3, the user may sign up in window 30 to the group application by creating an account by providing a user name, a password, a password confirmation and a phone number. As shown in FIG. 4, the user may enter a verification code in window 40, which is sent by the group selfie application to the messaging system of the telephone number provided by the user. As shown in FIG. 5, the user may select and store a plurality of contacts in window 50. As shown in FIG. 6, each contact is associated with a plurality of self-portrait photographs in window 60. As shown in FIG. 7, each self-portrait photograph may be edited, deleted or posted through social media in window 70. As shown in FIG. 8, each self-portrait photograph may be edited with text or filters in window 80. As shown in FIG. 9, each self-portrait photograph may be edited with filters in window 90. As shown in FIG. 10, each self-portrait photograph may be edited with text in window 100. As shown in FIG. 11, a given user may invite a list of selected user contacts to take a group selfie in window 110. As shown in FIG. 12, a selfie may be taken by the given user with a predetermined time period in window 120. As shown in FIG. 13, the user can select among a plurality of selfies in window 130.

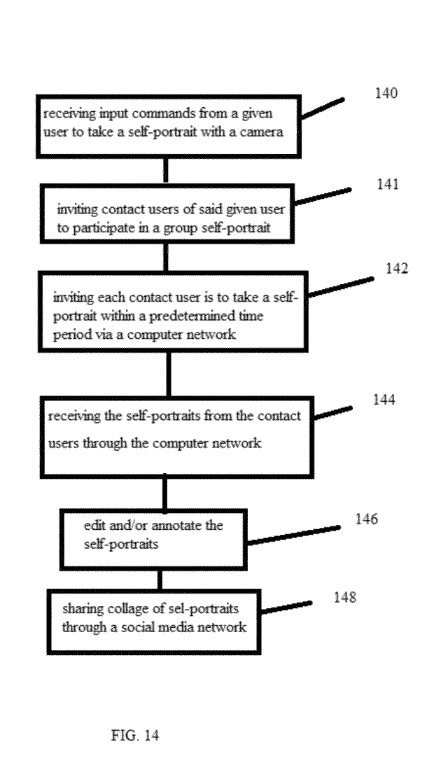

Referring to FIG. 14, there is shown an example of a computer implemented method for creating a group selfie. The method begins by at 140 receiving input commands from a given user to take a self-portrait with a camera. Then at step 141, the method continues by inviting contact users of the given user to participate in a group self-portrait. In this way, at step 142 each contact user is invited to take a self-portrait within a predetermined time period via a computer network. Then at step 144, the method continues by receiving the self-portraits from the contact users through the computer network. The given user can then edit and/or annotate the self-portraits to generate a collage at step 146. This collage may then be shared through a social media network at step 148.

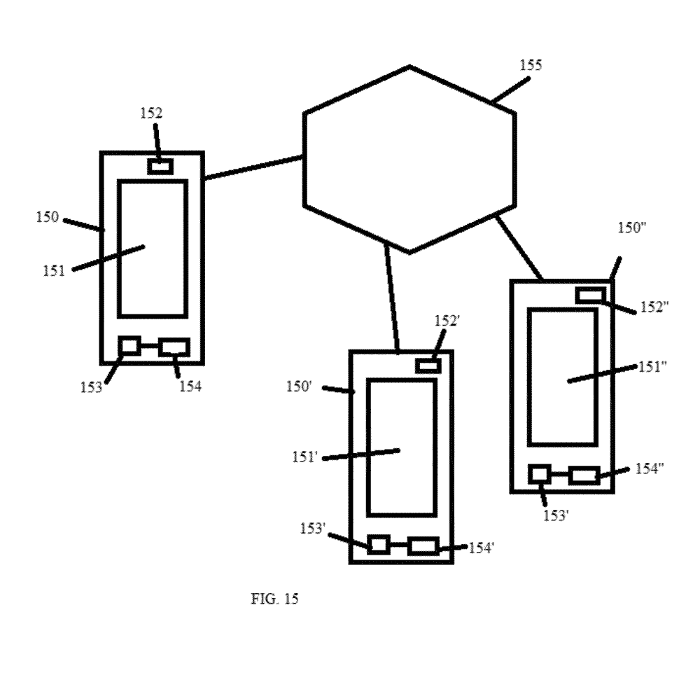

Referring to FIG. 15, there is shown an example of a system for creating group selfies. The system may include for example a device or apparatus 150 having a screen 151, a camera 152, a memory 153 and one or more processors coupled to the memory 154. The device 150 may me embodied by a wireless phone as described above. The memory 154 includes program instructions to receive input commands from a given user to take a self-portrait with the camera. The program instructions are configured to invite contact users of said given user to participate in a group self-portrait. As mentioned above, each contact user is invited to take a self-portrait within a predetermined time period via a computer network 155. The program instructions are also configured to receive the self-portraits from the contact users through the computer network 155. The contact users may also be provided with similar devices 150′ and 150″ as the given user's device 150. The devices 150′ and 150″ may have screen 151′ and 151″, a camera 152′ and 152″, a memory 153 and 153″, and one or more processors coupled to the memory 154′ and 154″.

In an embodiment, the program instructions of the device 150 may be configured to store the received self-portraits from the contact users in the memory 154. The program instructions of the device 150 may configured to receive input commands from the given user to edit the self-portrait of the given user and the self-portraits of the contact users. The program instructions of the device 150 may also be configured to receive input commands from the given user to annotate the self-portrait of the given user and the self-portraits of the contact users. The program instructions of the device 150 may also be configured to receive input commands from the given user to generate a collage of the self-portrait of the given user and the self-portraits of the contact users. The program instructions of the device 150 may also configured to receive input commands from the given user to share through a social network the collage of the self-portrait of the given user and the self-portraits of the contact users.

Although the present embodiments have been described with reference to specific example embodiments, it will be evident that various modifications and changes may be made to these embodiments without departing from the broader spirit and scope of the various embodiments. Accordingly, the specification and drawings are to be regarded in an illustrative rather than a restrictive sense.

What is claimed is:

1. A computer-implemented method comprising:
receiving input commands from a given user to take a self-portrait with a camera;
inviting contact users of said given user to participate in a group self-portrait, wherein each contact user is invited to take a self-portrait within a predetermined time period via a computer network; and
receiving the self-portraits from the contact users through the computer network.

2. The computer-implemented method of claim 1, further comprising receiving input commands from the given user to edit the self-portrait of the given user and the self-portraits of the contact users.

3. The computer-implemented method of claim 1, further comprising receiving input commands from the given user to annotate the self-portrait of the given user and the self-portraits of the contact users.

4. The computer-implemented method of claim 1, further comprising receiving input commands from the given user to generate a collage of the self-portrait of the given user and the self-portraits of the contact users.

5. The computer-implemented method of claim 4, further comprising receiving input commands from the given user to share through a social network the collage of the self-portrait of the given user and the self-portraits of the contact users.

6. A system comprising:
a screen;
a camera;
a memory; and
one or more processors coupled to the memory, wherein the memory comprises program instructions to:
receive input commands from a given user to take a self-portrait with the camera;
invite contact users of said given user to participate in a group self-portrait, wherein each contact user is invited to take a self-portrait within a predetermined time period via a computer network;
receive the self-portraits from the contact users through the computer network.

7. The system of claim 6, wherein the program instructions are configured to receive input commands from the given user to edit the self-portrait of the given user and the self-portraits of the contact users.

8. The system of claim 6, wherein the program instructions are configured to receive input commands from the given user to annotate the self-portrait of the given user and the self-portraits of the contact users.

9. The system of claim 6, wherein the program instructions are configured to receive input commands from the given user to generate a collage of the self-portrait of the given user and the self-portraits of the contact users.

10. The system of claim 9, wherein the program instructions are configured to receive input commands from the given user to share through a social network the collage of the self-portrait of the given user and the self-portraits of the contact users.

11. An apparatus configured to take a self-portrait, comprising
a screen;
a camera;
a memory; and
one or more processors coupled to the memory, wherein the memory comprises program instructions to:
receive input commands from a given user to take a self-portrait with the camera;
invite contact users of said given user to participate in a group self-portrait, wherein each contact user is invited to take a self-portrait within a predetermined time period via a computer network;
receive the self-portraits from the contact users through the computer network.

12. The apparatus of claim 11, wherein the program instructions are configured to store the received self-portraits from the contact users in the memory.

13. The apparatus of claim 11, wherein the program instructions are configured to receive input commands from the given user to edit the self-portrait of the given user and the self-portraits of the contact users.

14. The apparatus of claim 11, wherein the program instructions are configured to receive input commands from the given user to annotate the self-portrait of the given user and the self-portraits of the contact users.

15. The apparatus of claim 6, wherein the program instructions are configured to receive input commands from the given user to generate a collage of the self-portrait of the given user and the self-portraits of the contact users.

16. The system of claim 15, wherein the program instructions are configured to receive input commands from the given user to share through a social network the collage of the self-portrait of the given user and the self-portraits of the contact users.
